(19) United States
(12) Patent Application Publication
(10) Pub. No.: US 2014/0145101 A1
(43) Pub. Date: May 29, 2014

(54) ELECTROMAGNETIC VALVE DEVICE FOR HIGH-PRESSURE FLUID

(71) Applicant: DENSO CORPORATION, Kariya-city (JP)

(72) Inventors: Ryo ISHIBASHI, Anjo-city (JP); Akira TAKAGI, Obu-city (JP)

(73) Assignee: DENSO CORPORATION, Kariya-city (JP)

(21) Appl. No.: 14/090,248

(22) Filed: Nov. 26, 2013

(30) Foreign Application Priority Data
Nov. 27, 2012 (JP) 2012-258239

(51) Int. Cl. F16K 31/06

(52) U.S. Cl. CPC F16K 31/0658
USPC 251/129.15

(57) ABSTRACT

A guide portion made of a magnetic material can be filled with a gaseous fuel of high-pressure and is slidably receiving a movable core. The guide portion is constructed by a first small-diameter portion, a second small-diameter portion, and a magnetism blocking portion having a wall thickness less than that of the first small-diameter portion and the second small-diameter portion. When a magnetic circuit is generated by energizing the coil, a magnetic flux passing through the first small-diameter portion passes through the second small-diameter portion via an end face of the movable core and generates a magnetic attractive force inclining with respect to a center axis. Therefore, the movable core is moved to the stator core by the magnetic attractive force adding a magnetic attractive force generated by a magnetic circuit.

### CROSS-REFERENCE TO RELATED APPLICATION

This application is based on Japanese Patent Application No. 2012-258239 filed on Nov. 27, 2012, the disclosure of which is incorporated herein by reference.

### TECHNICAL FIELD

The present disclosure relates to an electromagnetic valve device for a high-pressure fluid, which blocks or allows a flow of the high-pressure fluid.

### BACKGROUND

It is known that a gaseous fuel supplying system depressurizes a pressure of a gaseous fuel supplied to an internal combustion engine from a high-pressure in a fuel tank to a low-pressure so that an injector for the gaseous fuel is capable of injecting the gaseous fuel. Hereafter, the internal combustion engine is referred to as an engine. An electromagnetic valve device for the gaseous fuel is provided in the gaseous fuel supplying system. The electromagnetic valve device for the gaseous fuel includes a valve driving portion and a valve member portion. The valve driving portion is constructed by a coil which generates magnetic force by energization, a stator core, a movable core, and a guide portion which is slidably receiving the movable core. The valve member is constructed by a valve member moving integrally with the movable core, and a valve seat. The electromagnetic valve device for the gaseous fuel cuts off a flow of the gaseous fuel of high-pressure to prevent the gaseous fuel of high-pressure from flowing into the injector for the gaseous fuel.

The electromagnetic valve device for the gaseous fuel has a self-seal function which improves an air tightness between the valve member and the valve seat by using the pressure of the gaseous fuel supplied by the fuel tank. Therefore, the guide portion of the electromagnetic valve device for the gaseous fuel is filled with the gaseous fuel of high-pressure so that the valve member is biased in a valve closing direction. Further, the guide portion has a pressure resistant to prevent a leak of the gaseous fuel.

When the valve member separates from the valve seat, a magnetic attractive force repelling the pressure of the gaseous fuel in the guide portion is generated between the movable core and the stator core. Therefore, a diameter of the movable core is increased.

In the electromagnetic valve device for the gaseous fuel, since the guide portion is slidably receiving the movable core having a large-diameter and has to be pressure resistant, the guide portion has a wall thickness thicker than that of the guide portion in which the high-pressure fluid is not fully filled. Generally, when a wall thickness of a guide portion made of a non-magnetic material becomes thicker, the magnetic attractive force generated relative to a value of a current flowing through the coil becomes smaller. To increase the magnetic attractive force between the movable core and the stator core, the current may be increased, or a number of reels of the coil may be increased. However, when the current is increased, an energy consumption amount is increased. When the number of reels of the coil is increased, a size of the electromagnetic valve device becomes larger. Japanese Patent No. 4871207 discloses a high-pressure electromagnetic valve having a magnetic field auxiliary member provided on a part of a guide portion radially outside of the guide portion. Further, the magnetic field auxiliary member is made of a magnetic material, and the guide portion is made of a non-magnetic material. JP-2011-108781A discloses a linear solenoid having a magnetism blocking portion for transferring magnetism from a space between the linear solenoid and a plunger to a stator core. Further, the stator core is made of a magnetic material and is slidably receiving the plunger.

However, in the high-pressure electromagnetic valve disclosed in Japanese Patent No. 4871207, since the guide portion is made of a non-magnetic material, the magnetic attractive force generated relative to the value of the current flowing through the coil cannot be increased large enough. Therefore, the size of the electromagnetic valve device becomes larger. Further, since the magnetic field auxiliary member is provided as another part, a number of parts is increased. Therefore, a cost of attachment is increased.

Since the linear solenoid disclosed in JP-2011-108781A is used to switch a flow of an operating fluid of relatively low-pressure at an operating pressure range, a leakage of oil as the operating fluid is allowed, and the linear solenoid has no self-seal function. Therefore, the linear solenoid disclosed in JP-2011-108781A cannot be used in the electromagnetic valve device for the high-pressure fluid.

### SUMMARY

It is an object of the present disclosure to provide an electromagnetic valve device for a high-pressure fluid, in which a flow of the high-pressure fluid is blocked or allowed, and the electromagnetic valve device can be miniaturized.

According to an aspect of the present disclosure, the electromagnetic valve device for the high-pressure fluid includes a coil assembly, a stator core, a movable core, a guide portion, a valve member, and a seat member. The coil assembly generates a magnetic force when being energized. The stator core is made of a magnetic material, and is excited when the coil assembly generates the magnetic force. The movable core is made of a magnetic material, and is moved to the stator core when the coil assembly generates the magnetic force. The guide portion slidably receives the movable core and is filled with the high-pressure fluid. The guide portion has a magnetism blocking portion which blocks a magnetic flux over a whole periphery of a predetermined position in an axial direction of the guide portion, and a magnetism passing portion through which the magnetic flux passes. The valve member is connected with the stator core. The seat member forms a valve seat abutting on or separating from the valve member to block or allow the flow of the high-pressure fluid. Further, when the coil assembly generates the magnetic force, a magnetic circuit bypassing the magnetism blocking portion is generated between the magnetism passing portion of the guide portion and the movable core.

In the electromagnetic valve device for the high-pressure fluid, the movable core is moved to the stator core by the magnetic circuit generated by energizing the coil assembly. In this case, the magnetic circuit is generated between the stator core and the movable core and between the magnetism passing portion of the guide portion and the movable core. The magnetic circuit generated between the magnetism passing portion and the movable core is relatively readily for the magnetic flux to pass, and is generated to incline with respect to a center axis of the guide portion by bypassing the magnetism blocking portion which is readily magnetically saturated because the magnetic flux relatively difficultly passes through. The magnetic circuit generates a magnetic attractive force to move the movable core to the stator core. The movable core is moved to the stator core by not only the magnetic attractive force generated according to the magnetic circuit between the stator core and the movable core but also the magnetic attractive force generated according to the magnetic circuit between the magnetism passing portion and the movable core. Therefore, comparing to the movable core moved only by the magnetic attractive force generated according to the magnetic circuit between the stator core and the movable core, a facing area of the movable core relative to the stator core can be made smaller, and a diameter of the movable core can be made smaller. Thus, the size of the electromagnetic valve device for the high-pressure fluid can be made smaller.

Further, since the diameter of the movable core of the electromagnetic valve device for the high-pressure fluid becomes smaller, a diameter of the guide portion slidably receiving the movable core becomes smaller. When the diameter of the guide portion is decreased, a pressure resistance of the guide portion repelling a pressure of the gaseous fuel filled in the guide portion is improved. Therefore, in a case where the high-pressure fluids with the same pressure are filled, comparing to the electromagnetic valve device for the high-pressure fluid having the movable core moved only by the magnetic attractive force generated according to the magnetic circuit between the stator core and the movable core, a wall thickness of the guide portion can be made thinner. Thus, the size of the electromagnetic valve device for the gaseous fuel can be made further smaller.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an outline of a gaseous fuel supplying system to which an electromagnetic valve device for a gaseous fuel is applied, according to a first embodiment of the present disclosure;

FIG. 2 is a sectional view showing the electromagnetic valve device for the gaseous fuel, according to the first embodiment;

FIG. 3 is a sectional view showing the electromagnetic valve device for the gaseous fuel in a different operation from FIG. 2, according to the first embodiment;

FIG. 4 is a sectional view showing the electromagnetic valve device for the gaseous fuel in a different operation from FIGS. 2 and 3, according to the first embodiment;

FIG. 5 is a sectional view showing the electromagnetic valve device for the gaseous fuel, according to a second embodiment of the present disclosure;

FIG. 6 is a sectional view showing the electromagnetic valve device for the gaseous fuel, according to a third embodiment of the present disclosure; and

FIG. 7 is a sectional view showing the electromagnetic valve device for the gaseous fuel, according to a fourth embodiment of the present disclosure.

### DETAILED DESCRIPTION

Embodiments of the present disclosure will be described. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, embodiments of the present disclosure will be described with reference to drawings.

### First Embodiment

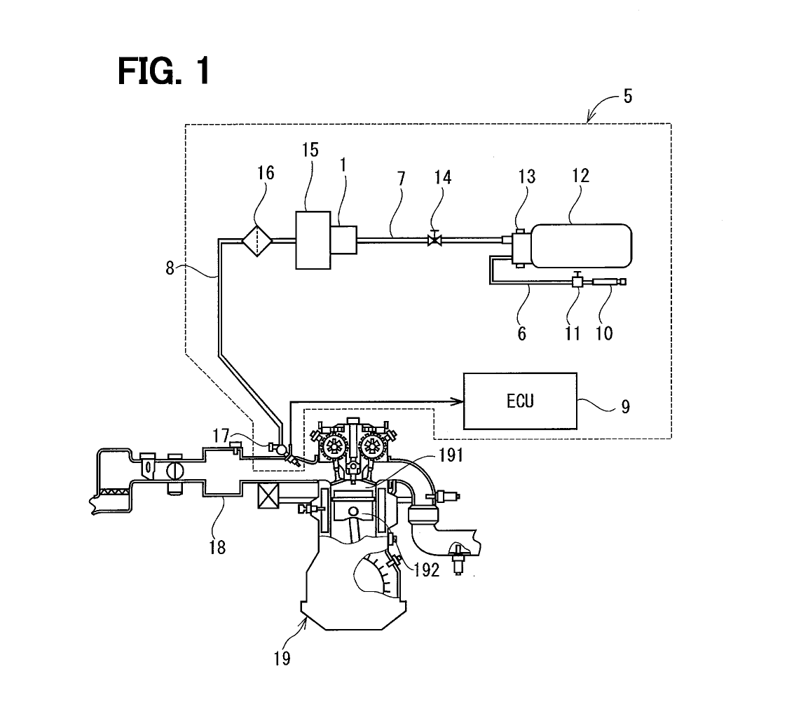

Referring to FIGS. 1 to 4, an electromagnetic valve device 1 for a gaseous fuel according to a first embodiment of the present disclosure will be detailed.

First, a gaseous fuel supplying system to which the electromagnetic valve device 1 is applied will be described with reference to FIG. 1. The gaseous fuel supplying system 5, for example, is mounted to a vehicle using a compressed natural gas as fuel. The gaseous fuel supplying system 5 includes a gas inlet 10, a fuel tank 12, the electromagnetic valve device 1, a pressure control valve 15 for the gaseous fuel, an injector 17 for the gaseous fuel, and an electrical control unit 9. According to the present disclosure, the injector 17 corresponds to an injection portion.

The gaseous fuel of high-pressure is supplied from external to the gas inlet 10, and is introduced into and stored in the fuel tank 12 via a supply pipe 6. The gas inlet 10 has a back-flow preventing function to control the gaseous fuel so that the gaseous fuel supplied from the gas inlet 10 does not backflow to external. The supply pipe 6 is provided with a gas filling valve 11.

The fuel tank 12 is provided with a fuel tank valve 13. The fuel tank valve 13 has a back-flow prevention function, an excess flow prevention function, and a pressurization prevention function. The back-flow prevention function of the fuel tank valve 13 is for preventing the gaseous fuel from back-flowing from the fuel tank 12 to the gas inlet 10. The excess flow prevention function is for blocking a flow of the gaseous fuel from the fuel tank 12 in a case where a flow amount of the gaseous fuel flowing through a supply tube 7 is greater than or equal to a predetermined amount. The pressurization prevention security function is for preventing a damage of the fuel tank 12 by opening the fuel tank 12 to external in a case where a pressure in the fuel tank 12 is increased.

The fuel tank valve 13 is connected with the electromagnetic valve device 1 via the supply tube 7. The supply tube 7 is provided with a master valve 14 capable of manually blocking the supply tube 7.

The electromagnetic valve device 1 is placed at a position upstream of the pressure control valve 15. That is, the electromagnetic valve device 1 is positioned between the pressure control valve 15 and the fuel tank 12. When a pressure of the gaseous fuel flowing downstream of the pressure control valve 15 is greater than or equal to a predetermined pressure, the electromagnetic valve device 1 blocks the flow of the gaseous fuel introduced into the pressure control valve 15 according to a command of the ECU 9. The electromagnetic valve device 1 blocks or allows a flow of the gaseous fuel by an electromagnetic valve which is not shown.

The pressure control valve 15 depressurizes the pressure of the gaseous fuel supplied from the supply tube 7 to a pressure so that the injector 17 is capable of injecting the gaseous fuel. For example, the pressure control valve 15 depressurizes a high-pressure of the gaseous fuel in the fuel tank 12 to a low-pressure so that the injector 17 is capable of injecting the gaseous fuel. In this case, the high-pressure is 20 MPa, and the low-pressure is within a pressure range from 0.2 MPa to 0.65 MPa.

In the gaseous fuel depressurized by the pressure control valve 15, oil is removed by an oil filter 16. Then, the gaseous fuel is supplied to the injector 17 via a supply duct 8. The injector 17 injects the gaseous fuel into an intake pipe 18 according to an indication of the ECU 9 which is electrically connected with the injector 17. The injector 17 is provided with a temperature sensor and a pressure senor which are not shown. A temperature of the gaseous fuel and the pressure of the gaseous fuel which are detected by the temperature sensor and the pressure sensor, respectively, are outputted to the ECU 9.

The gaseous fuel injected into the intake pipe 18 is mixed with an air introduced from the atmosphere. Then, a mixed gas is introduced into a cylinder 191 from an intake port of an engine 19. In this case, the mixed gas is the gaseous fuel mixed with the air, and the engine 19 is connected with the intake pipe 18 and is used as an internal combustion engine. In the engine 19, a rotational torque is generated by a compression and a combustion of the mixed gas according to a lifting of a piston 192.

The gaseous fuel supplying system 5 depressurizes the pressure of the gaseous fuel in the fuel tank 12 to the pressure so that the injector 17 is capable of injecting the gaseous fuel, and supplies the gaseous fuel to the engine 19 by the injector 17.

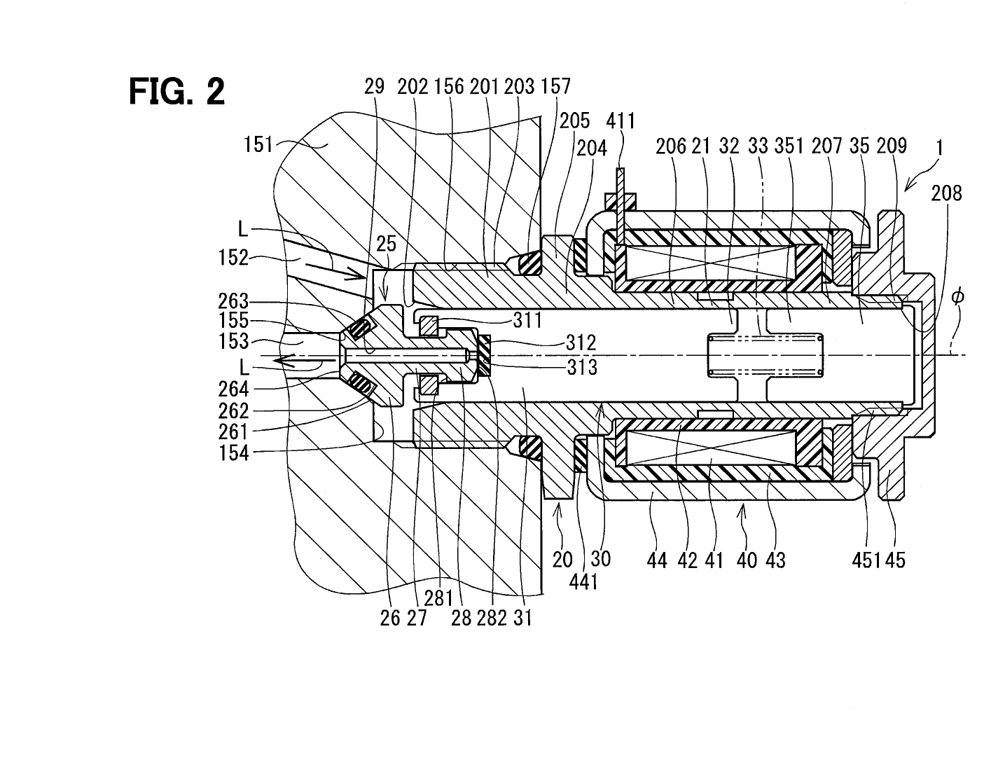

Next, a configuration of the electromagnetic valve device 1 will be described with reference to FIGS. 2 to 4. Solid arrows L shown in FIGS. 2 to 4 indicate flow directions of the gaseous fuel.

The electromagnetic valve device 1 is constructed by a support member 151, a guide portion 20, a valve member 25, a movable core 30, a stator core 35, and a coil assembly 40. The above parts are provided in order of the support member 151, the valve member 25, the movable core 30 and the stator core 35.

The support member 151 supports the guide portion 20. According to the first embodiment, the support member 151 corresponds to a valve body of the pressure control valve 15 connected with a downstream end of the electromagnetic valve device 1. It is not limited to the above configuration. For example, the support member 151 may be provided as another part different from the valve body of the pressure control valve 15.

The support member 151 includes an inlet passage 152, an outlet passage 153, and a concave portion 154. The concave portion 154 communicates with the inlet passage 152 and the outlet passage 153. The gaseous fuel in the fuel tank 12 is supplied to the inlet passage 152 via the supply tube 7. The gaseous fuel is exhausted from the outlet passage 153 towards the pressure control valve 15.

The concave portion 154 is provided so that the concave portion 154 has an opening on an outer wall of the support member 151. A valve seat 155 is a part of an inner wall of the concave portion 154, and is taper-shaped so that the valve seat 155 is inclined from the concave portion 154 to the outlet passage 153. That is, according to the first embodiment, a seat member of the present disclosure, which forms the valve seat 155, and the support member 151 are integrally bonded to each other as one member. Further, an internal-screw groove 156 is provided in the inner wall of the concave portion 154 which is substantially perpendicular to the outer wall of the support member 151. The guide portion 20 is attached to the concave portion 154 by using the internal-screw groove 156.

The guide portion 20 is substantially tube-shaped and made of a magnetic material such as a magnetic stainless steel including chromium from 13 wt % to 17 wt %. The guide portion 20 is constructed by a large-diameter portion 201, a medium-diameter portion 204, a ring portion 205, a first small-diameter portion 206, a magnetism blocking portion 21, and a second small-diameter portion 207. In the guide portion 20, the large-diameter portion 201, the medium-diameter portion 204, the ring portion 205, the first small-diameter portion 206, the magnetism blocking portion 21 and the second small-diameter portion 207 are integrally bonded to each other. The guide portion 20 is slidably receiving the movable core 30 in an axial direction of the guide portion 20. The guide portion 20 is provided to be filled with and not to leak the gaseous fuel of high-pressure from the inlet passage 152 to the outlet passage 153 via the concave portion 154.

The large-diameter portion 201 substantially tube-shaped has an opening 202 and an external-screw groove 203. The movable core 30 or the valve member 25 slides into or out of the guide portion 20, through the opening 202. The external-screw groove 203 provided radially outside of the large-diameter portion 201 is screwed with the internal-screw groove 156 of the support member 151.

The medium-diameter portion 204 substantially tube-shaped has a periphery less than that of the large-diameter portion 201. A first end part of the medium-diameter portion 204 is connected with an end part of the large-diameter portion 201 opposite to the opening 202. The ring portion 205 having a periphery greater than that of the large-diameter portion 201 is provided radially outside of the medium-diameter portion 204.

When the guide portion 20 is attached to the support member 151, or when the guide portion 20 is detached from the support member 151, a rotational torque is applied to the ring portion 205 by tools. A seal member 157 is provided between the ring portion 205 and the support member 151 so as to prevent the gaseous fuel from being leaked from the concave portion 154.

The first small-diameter portion 206 having a periphery less than that of the medium-diameter portion 204 is substantially tube-shaped. A first end part of the first small-diameter portion 206 is connected with a second end part of the medium-diameter portion 204. According to the first embodiment, the first small-diameter portion 206 corresponds to a magnetism passing portion.

The magnetism blocking portion 21 is substantially tube-shaped, and has an end part which is connected with a second end part of the first small-diameter portion 206. The magnetism blocking portion 21 is provided in the vicinity of a first end part 32 of the movable core 30 of when the valve member 25 abuts on the valve seat 155. In this case, a position of the magnetism blocking portion 21 corresponds to a predetermined position. The first end part 32 is an end part of the movable core 30 close to the stator core 35. The magnetism blocking portion 21 has the same inner diameter with the first small-diameter portion 206 and the second small-diameter portion 207, and has a periphery less than that of the first small-diameter portion 206 and the second small-diameter portion 207. In other words, the magnetism blocking portion 21 has a wall thickness less than that of the first small-diameter portion 206 and the second small-diameter portion 207. According to the first embodiment, the magnetism blocking portion 21 is provided to have the wall thickness from 0.6 mm to 0.9 mm.

The second small-diameter portion 207 substantially tube-shaped has a periphery less than that of the medium-diameter portion 204 and greater than that of the magnetism blocking portion 21. The second small-diameter portion 207 has a first end part connected with the magnetism blocking portion 21, and a second end part having a port 208 and an external-thread groove 209. The stator core 35 is positioned at an interior of the port 208. The external-thread groove 209 provided radially outside of the second small-diameter portion 207 is screwed with an internal-thread groove 451 provided on a cover portion 45. According to the first embodiment, the second small-diameter portion 207 corresponds to the magnetism passing portion.

The valve member 25 is constructed by a contact portion 26, a small-radius portion 27, and a large-radius portion 28. The contact portion 26, the small-radius portion 27 and the large-radius portion 28 which are made of a non-magnetic material are integrally bonded to each other. The valve member 25 is abutting on or separating from the valve seat 155, according to a sliding movement of the movable core 30.

The contact portion 26 which is a truncated-cone shape has an incline surface 261 capable of abutting on or separating from the valve seat 155. The incline surface 261 has a receiving chamber 262. The receiving chamber 262 which is ring-shaped has a concave shape in a sectional view. The receiving chamber 262 receives a seal portion 263. When the incline surface 261 abuts on the valve seat 155, the seal portion 263 holds an airtight state between the concave portion 154 and the outlet passage 153.

The small-radius portion 27 has a first end part connected with a first end part of the contact portion 26 opposite to the incline surface 261. The small-radius portion 27 has a periphery which is less than the maximum periphery of the contact portion 26 and a periphery of the large-radius portion 28.

The large-radius portion 28 has a first end part which is connected with a second end part of the small-radius portion 27. A step surface 281 is provided at the first end part of the large-radius portion 28 connected with the small-radius portion 27. An end surface 282 capable of abutting on a seal element 312 is provided at a second end part of the large-radius portion 28 opposite to the step surface 281.

The valve member 25 further includes a through hole 29 in an axial direction of the valve member 25. Openings of the through hole 29 are defined by both an edge surface 264 positioned at a second end part of the contact portion 26 and the end surface 282 of the large-radius portion 28.

The movable core 30 is a rod-shaped member made of a magnetic material such as a magnetic stainless steel. The movable core 30 is slidably received in the guide portion 20. A plating film is provided on a side wall of the movable core 30. Further, the side wall is arranged outside of the movable core 30 in a radial direction of the movable core 30, and is slidable in the guide portion 20.

A second end part 31 of the movable core 30 is concave-shaped, and receives the large-radius portion 28 and a part of the small-radius portion 27 of the valve member 25. In this case, an outer wall of the large-radius portion 28 and an inner wall of the second end part 31 define a gap. A limit member 311 which is ring-shaped is provided at an inner wall of an edge part of the second end part 31. When the valve member 25 moves in a direction separating the valve member 25 from the movable core 30, the limit member 311 abuts on the step surface 281. Therefore, a distance of the valve member 25 relatively moving with respect to the movable core 30 is limited. The valve member 25 is indirectly connected with the movable core 30 via the limit member 311. Further, a receiving room 313 which receives the seal element 312 is defined by the inner wall of the second end part 31.

The first end part 32 which is concave-shaped locks a first end part of a spring 33.

The stator core 35 is a rod-shaped member made of a magnetic material. The stator core 35 is fixed in the second small-diameter portion 207. An end part 351 of the stator core 35 close to the movable core 30 is concave-shaped, and locks a second end part of the spring 33.

The spring 33 is placed at a position of the guide portion 20 between the stator core 35 and the movable core 30. The spring 33 biases the movable core 30 in a separating direction separating the movable core 30 from the stator core 35. According to the first embodiment, the spring 33 corresponds to a biasing member.

The coil assembly 40 is provided to surround the guide portion 20 radially outside of the guide portion 20. The coil assembly 40 is constructed by a coil 41, a bobbin 42, a cover 43, and a yoke 44.

When the coil 41 is energized, a magnetic field is generated around the coil 41 by a current flowing through the coil 41 via a connector 411. The connector 411 is provided radially outside of the coil assembly 40.

The bobbin 42 and the cover 43 are non-magnetic members which are provided to cover the coil 41. The yoke 44 which is made of a magnetic material is provided radially outside of the bobbin 42 and a radial direction of the cover 43. The yoke 44 is crimped at both end parts to receive the coil 41, the bobbin 42 and the cover 43.

An elastic member 441 is provided between the yoke 44 and the ring portion 205. The elastic member 441 biases the coil assembly 40 in a direction towards the stator core 35 to separate the coil assembly 40 from the ring portion 205.

The cover portion 45 which is tube-shaped is a metal member having a bottom. The internal-thread groove 451 is provided on an inner wall of the cover portion 45. The cover portion 45 is attached to the second small-diameter portion 207 by using the internal-thread groove 451.

Next, effects of the electromagnetic valve device 1 will be described with reference to FIGS. 2 to 4.

When the current does not flow through the coil 41, only a biasing force of the spring 33 is applied to the movable core 30, thereby biasing the movable core 30 in the separating direction separating the movable core 30 from the stator core 35. Further, the concave portion 154 communicates with the inlet passage 152, and the concave portion 154 is filled with the gaseous fuel of high-pressure. Then, the end surface 282 of the valve member 25 abuts on the seal element 312, and the incline surface 261 of the valve member 25 supported by the movable core 30 abuts on the valve seat 155. Thus, the inlet passage 152 is blocked from communicating with the outlet passage 153.

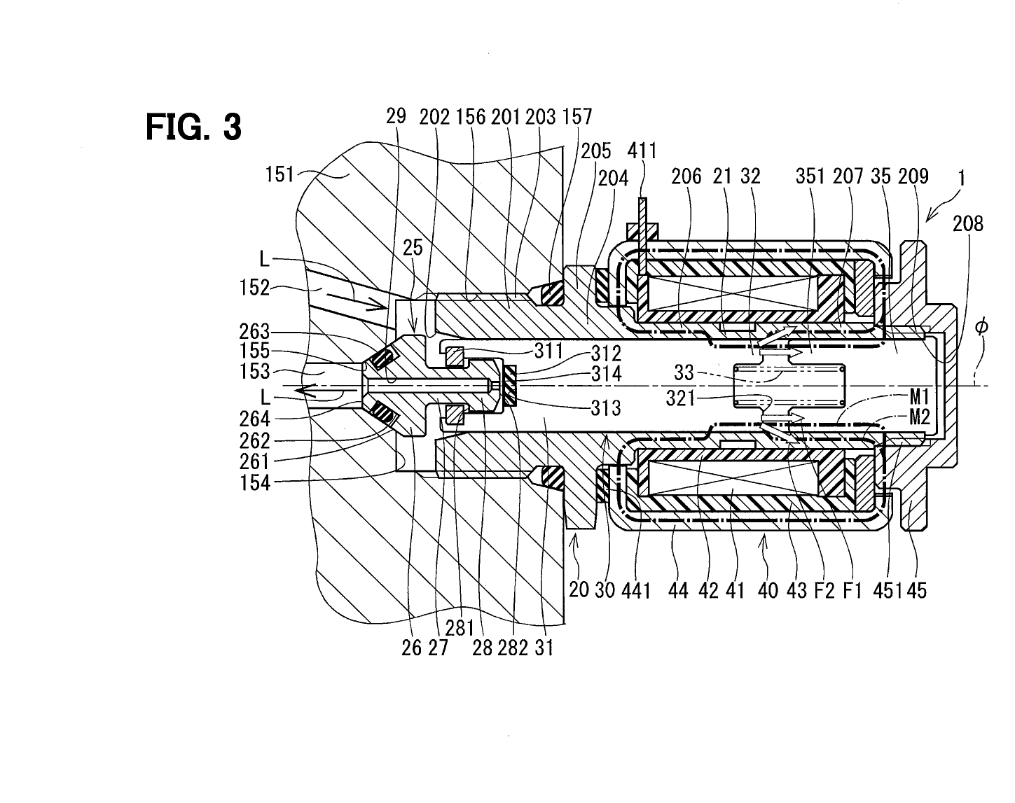

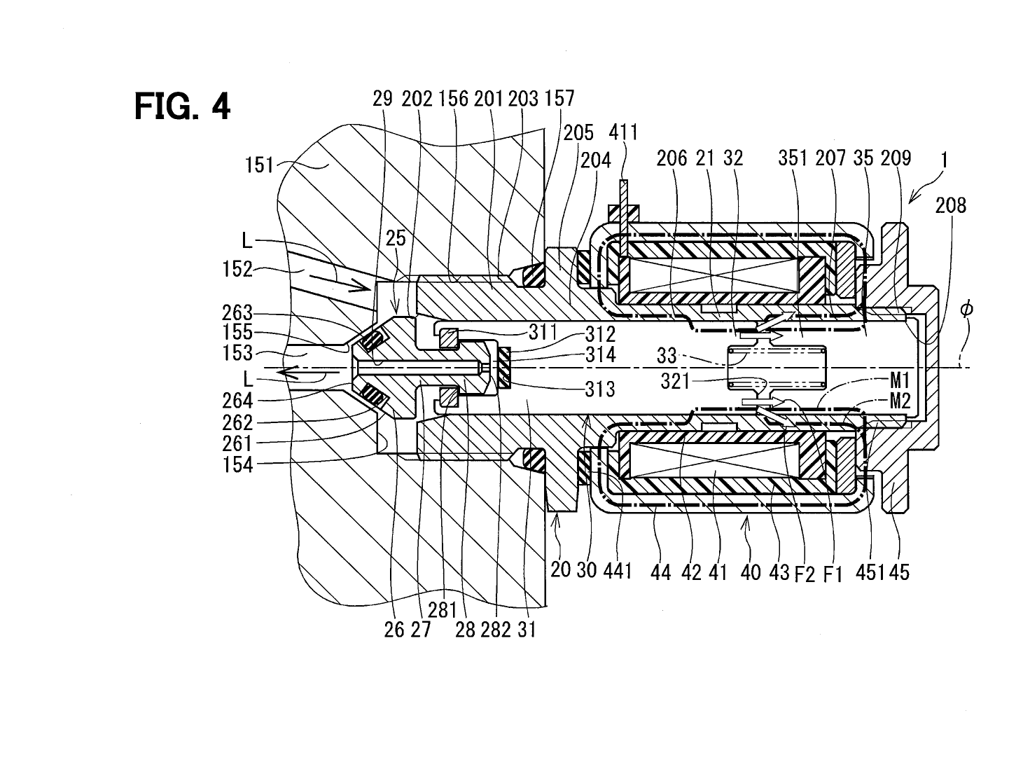

When the current flows through the coil 41, magnetic circuits are generated around the coil 41. A first magnetic circuit M1 is a magnetic circuit of the magnetic circuits as shown in FIGS. 3 and 4. The first magnetic circuit M1 is generated so that a magnetic flux passes from the yoke 44 back to the yoke 44 through the first small-diameter portion 206, the first end part 32, the stator core 35, the second small-diameter portion 207 and the cover portion 45. When the first magnetic circuit M1 is generated, the stator core 35 is excited.

When the current flowing through the coil 41 is small, a magnetic circuit is generated so that the magnetic flux passes from the yoke 44 back to the yoke 44 through the first small-diameter portion 206, the magnetism blocking portion 21, the second small-diameter portion 207 and the cover portion 45. However, since the wall thickness of the magnetism blocking portion 21 is thinner than that of the first small-diameter portion 206 and the second small-diameter portion 207, the magnetism blocking portion 21 is readily magnetically saturated. When the current flowing through the coil 41 is increased, the magnetic circuit becomes a magnetic circuit generated to bypass the magnetism blocking portion 21 so that the magnetic flux passes from the yoke 44 back to the yoke 44 through the first small-diameter portion 206, the first end part 32, the second small-diameter portion 207 and the cover portion 45. In this case, the magnetism blocking portion 21 blocks the magnetic flux over a whole periphery of the guide portion 20 in the axial direction of the guide portion 20. When the current flowing through the coil 41 is further increased, an area between the movable core 30 and the second small-diameter portion 207 is magnetically saturated. The magnetic flux passing through the yoke 44 and the first small-diameter portion 206 passes through an interior of the movable core 30. Then, the magnetic flux passes through an end face 321 of the first end part 32 close to the stator core 35, the second small-diameter portion 207 and the cover portion 45 to form a magnetic circuit. As shown in FIGS. 3 and 4, a second magnetic circuit M2 is a magnetic circuit generated so that the magnetic flux passes from the yoke 44 back to the yoke 44 through the first small-diameter portion 206, the end face 321, the second small-diameter portion 207 and the cover portion 45.

When the first magnetic circuit M1 is generated, a first magnetic attractive force F1 is generated between the movable core 30 and the stator core 35. The first magnetic attractive force F1 is a magnetic attractive force in a direction parallel to a center axis φ of the guide portion 20 as shown in FIGS. 3 and 4. When the second magnetic circuit M2 is generated, a second magnetic attractive force F2 is generated between the movable core 30 and the second small-diameter portion 207. The second magnetic attractive force F2 is a magnetic attractive force inclining with respect to the center axis φ. According to the present disclosure, the first and second magnetic attractive force F1 and F2 correspond to a magnetic force.

As the above description, when the current flows through the coil 41, the movable core 30 moves in the direction towards the stator core 35 by canceling the biasing force of the spring 33 according to the first and second magnetic attractive forces F1 and F2. When the movable core 30 moves in the direction towards the stator core 35, the end surface 282 separates from the seal element 312, as shown in FIG. 3. The gaseous fuel of high-pressure which has been filled in the concave portion 154 flows into a space 314 through a gap between the limit member 311 and an outer wall of the small-radius portion 27 and the gap between the inner wall of the second end part 31 and the outer wall of the large-radius portion 28. The space 314 is defined by the end surface 282 and the seal element 312. The gaseous fuel of the space 314 flows into the outlet passage 153 via the through hole 29. Thus, a difference between the pressure of the gaseous fuel in the concave portion 154 and the pressure of the gaseous fuel in the outlet passage 153 is decreased.

Further, when the movable core 30 moves in the direction towards the stator core 35, the limit member 311 abuts on the step surface 281 of the valve member 25. When the movable core 30 further moves in the direction towards the stator core 35, the valve member 25 moves together with the movable core 30 in the direction towards the stator core 35, and the incline surface 261 separates from the valve seat 155 as shown in FIG. 4. Thus, the gaseous fuel of the concave portion 154 flows into the outlet passage 153 via a gap between the incline surface 261 and the valve seat 155.

(1) In the electromagnetic valve device 1, two magnetic circuits M1 and M2 are generated in a case where the coil 41 is energized. The second magnetic circuit M2 is generated so that the magnetic flux bypasses the magnetism blocking portion 21 and passes through the second small-diameter portion 207, the first end part 32 of the movable core 30 and the first small-diameter portion 206. In this case, the second magnetic attractive force F2 inclining with respect to the center axis φ is generated between the guide portion 20 and the first end part 32. The movable core 30 is moved in the direction towards the stator core 35 according to a part of the second magnetic attractive force F2 parallel to the center axis φ. That is, in the electromagnetic valve device 1, the movable core 30 is moved in the direction towards the stator core 35 by not only the first magnetic attractive force F1 generated according to the first magnetic circuit M1 but also the second magnetic attractive force F2 generated according to the second magnetic circuit M2. In a case where the same magnetic attractive forces are generated, comparing to an electromagnetic valve device for a high-pressure fluid having a movable core moved only by a magnetic attractive force generated according to a magnetic circuit between a stator core and the movable core, a facing area of the movable core 30 relative to the stator core 35 can be made smaller. Thus, a diameter of the movable core 30 can be made smaller, and a size of the electromagnetic valve device 1 can be made smaller.

(2) Further, since the diameter of the movable core 30 is decreased, the wall thickness of the guide portion 20 having a pressure resistance relative to the gaseous fuel of high-pressure filled in the guide portion 20 can be made relatively thinner.

Specifically, the pressure of the gaseous fuel in the guide portion 20 is referred to as a pressure P, and the unit of the pressure P is Pa. An inner diameter of the guide portion 20 is referred to as an inner diameter D, and the unit of the inner diameter D is m. The wall thickness of the guide portion 20 is referred to as a wall thickness T, and the unit of the wall thickness T is m. A first stress σ1 represents a stress in a direction parallel to the center axis φ, and the unit of the first stress σ1 is N. A second stress σ2 represents a stress in a radial direction, and the unit of the second stress σ2 is N. The relationship between the above parameters is indicated as following formulas.

σ1=(P*D)/(4*T) (i)

σ2=(P*D)/(2*T) (ii)

According to formulas (i) and (ii), when the inner diameter D is increased, the first stress σ1 in the direction parallel to the center axis φ and the second stress σ2 in the radial direction are increased. Then, it is necessary to increase the wall thickness T so as to hold the first stress σ1 and the second stress σ2. In the electromagnetic valve device 1, the inner diameter is relatively small, so the first stress σ1 and the second stress σ2 are decreased. Thus, the wall thickness T can be made smaller. Therefore, the size of the electromagnetic valve device 1 can be made further smaller.

(3) Further, in the electromagnetic valve device 1, the magnetism blocking portion 21 which has the wall thickness thinner than that of the first small-diameter portion 206 and the second small-diameter portion 207 is provided at a position relatively far away from a position where the guide portion 20 and the support member 151 are connected with each other. Thus, when a force from external is applied to the electromagnetic valve device 1, a moment of a force applied to the magnetism blocking portion 21 can be decreased. In this case, the moment uses the position where the guide portion 20 and the support member 151 are connected with each other as a center. Thus, a damage of the electromagnetic valve device 1 can be prevented.

(4) The spring 33 provided between the movable core 30 and the stator core 35 biases the movable core 30 in the separating direction separating the movable core 30 from the stator core 35. Thus, when the current flowing through the coil 41 becomes zero, and when the first and second magnetic attractive forces F1 and F2 become zero, the movable core 30 is rapidly moved in a direction towards the support member 151, and the valve member 25 abuts on the valve seat 155. Thus, a closing motion of the electromagnetic valve device 1 can be rapidly executed.

(5) The movable core 30 uses a magnetic stainless steel with a high saturated magnetic-flux density as a base material. Further, the plating film having a high abrasion resistance is made of a non-magnetic material and is provided on the side wall of the movable core 30. The side wall is arranged outside of the movable core 30 in the radial direction of the movable core 30, and is slidable in the guide portion 20. Thus, the movable core 30 obtains a high magnetism passing function for forming the magnetic circuit and an abrasion resistance function for difficultly deforming itself. Thus, the size of the electromagnetic valve device 1 can be made smaller, and a deformation of the electromagnetic valve device 1 due to abrasion can be prevented.

### Second Embodiment

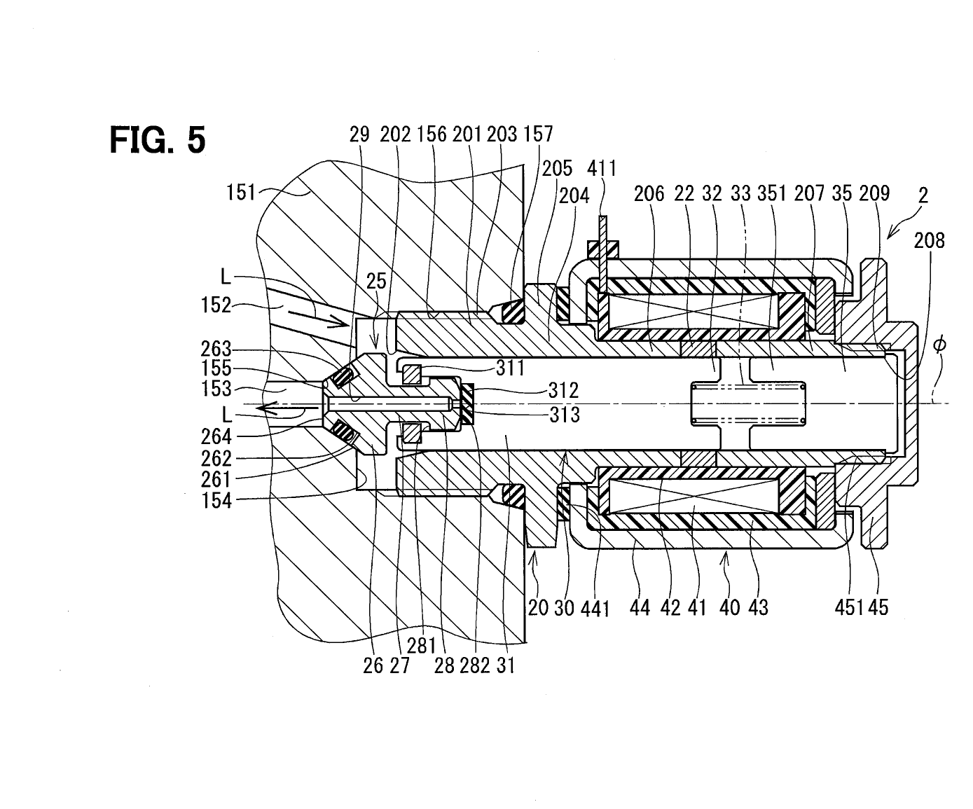

Next, an electromagnetic valve device for the gaseous fuel according to a second embodiment of the present disclosure will be described with reference to FIG. 5. The second embodiment has features different from the first embodiment. Specifically, in the second embodiment, material to form the magnetism blocking portion and a shape of the magnetism blocking portion are different from those of the first embodiment. The substantially same parts and the components as the first embodiment are indicated with the same reference numeral and the same description will not be reiterated.

In the electromagnetic valve device 2 according to the second embodiment, as shown in FIG. 5, the guide portion 20 further includes the magnetism blocking portion 22 having the same wall thickness as the first small-diameter portion 206 and the second small-diameter portion 207. The magnetism blocking portion 22 is made of a non-magnetic material modified by a reformulation operation, so that the magnetism blocking portion 22 is magnetically saturated more readily than the first small-diameter portion 206 and the second small-diameter portion 207.

In the electromagnetic valve device 2, the guide portion 20 made of a magnetic material has the magnetism blocking portion 22 made of a non-magnetic material modified by the reformulation operation. Thus, the second magnetic circuit M2 generated by the coil 41 bypasses the magnetism blocking portion 22, and is generated between the first small-diameter portion 206 and the movable core 30 and between the second small-diameter portion 207 and the movable core 30. Thus, the electromagnetic valve device 2 can accomplish effects (1), (2), (4) and (5) in the first embodiment.

### Third Embodiment

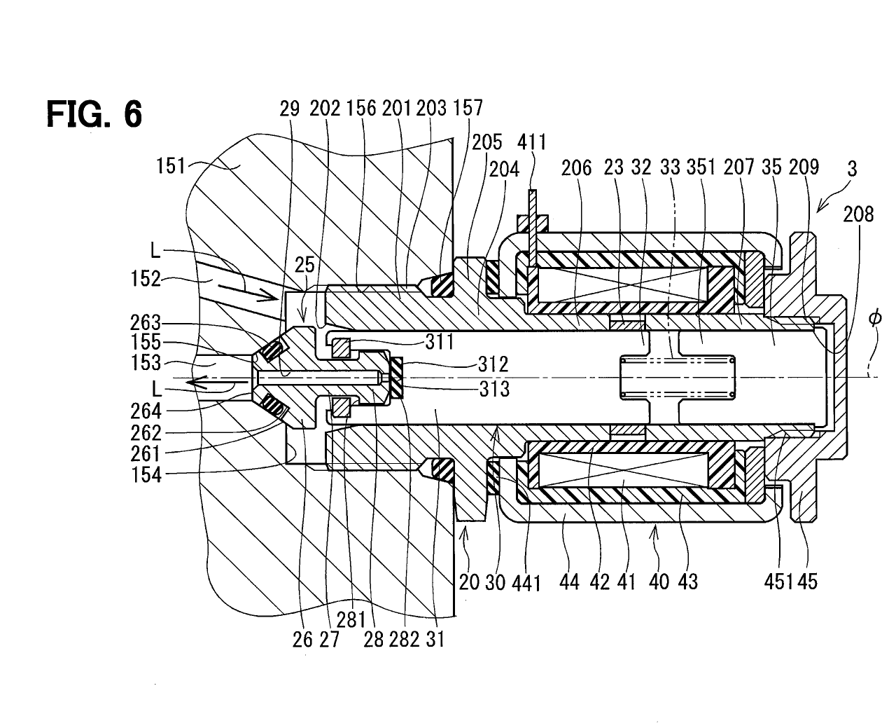

Next, an electromagnetic valve device for the gaseous fuel according to a third embodiment of the present disclosure will be described with reference to FIG. 6. The third embodiment has features different from the first embodiment. Specifically, in the third embodiment, material to form the magnetism blocking portion is different from that of the first embodiment. The substantially same parts and the components as the first embodiment are indicated with the same reference numeral and the same description will not be reiterated.

In the electromagnetic valve device 3 according to the third embodiment, as shown in FIG. 6, the guide portion 20 further includes the magnetism blocking portion 23 having a wall thickness less than that of the first small-diameter portion 206 and the second small-diameter portion 207. The magnetism blocking portion 23 is made of a non-magnetic material modified by the reformulation operation, so that the magnetism blocking portion 23 is magnetically saturated more readily than the first small-diameter portion 206 and the second small-diameter portion 207.

In the electromagnetic valve device 3, the guide portion 20 made of a magnetic material has the magnetism blocking portion 23 having a thin wall thickness and made of a non-magnetic material modified by the reformulation operation. Thus, the second magnetic circuit M2 generated by the coil 41 bypasses the magnetism blocking portion 23, and is generated between the first small-diameter portion 206 and the movable core 30 and between the second small-diameter portion 207 and the movable core 30. Thus, the electromagnetic valve device 3 can accomplish effects (1), (2), (3), (4) and (5) in the first embodiment.

### Fourth Embodiment

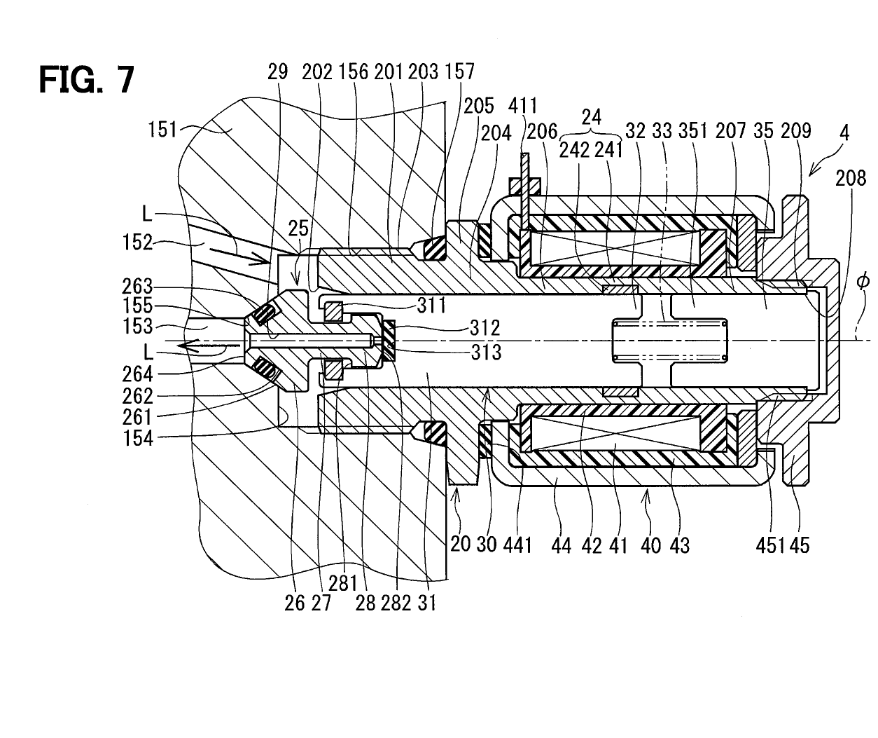

Next, an electromagnetic valve device for the gaseous fuel according to a fourth embodiment of the present disclosure will be described with reference to FIG. 7. The fourth embodiment has features different from the second embodiment. Specifically, in the fourth embodiment, material to form a part of a magnetism blocking area is different from that of the second embodiment. The substantially same parts and the components as the second embodiment are indicated with the same reference numeral and the same description will not be reiterated.

In the electromagnetic valve device 4 according to the fourth embodiment, as shown in FIG. 7, the guide portion 20 further includes the magnetism blocking portion 24 having the same wall thickness as the first small-diameter portion 206 and the second small-diameter portion 207. The magnetism blocking portion 24 is constructed by a non-magnetic portion 242 and a magnetic portion 241. The non-magnetic portion 242 is made of a non-magnetic material modified by the reformulation operation, and the magnetic portion 241 is made of a magnetic material. Further, the non-magnetic portion 242 is provided inside of the magnetic portion 241 in the radial direction. When the magnetic circuit is generated around the coil 41 after the coil 41 is energized, the magnetism blocking portion 24 is readily magnetically saturated.

In the electromagnetic valve device 4, the magnetism blocking portion 24 has the non-magnetic portion 242 made of a non-magnetic material modified by the reformulation operation. Thus, the second magnetic circuit M2 generated by the coil 41 bypasses the magnetism blocking portion 24, and is generated between the first small-diameter portion 206 and the movable core 30 and between the second small-diameter portion 207 and the movable core 30. Thus, the electromagnetic valve device 4 can accomplish effects (1), (2), (4) and (5) in the first embodiment, as the same as the second embodiment.

### Other Embodiment

(a) According to the above embodiments, the electromagnetic valve device for the gaseous fuel is applied to a gaseous fuel supply system in which the gaseous fuel is supplied to the engine, and blocks or allows the flow of the gaseous fuel. However, the electromagnetic valve device for the gaseous fuel of the present disclosure is not limited to the above system. The electromagnetic valve device for the gaseous fuel may be applied to a supply system supplying the high-pressure fluid.

(b) According to the above embodiments, the electromagnetic valve device for the gaseous fuel in which the through hole is provided in the valve member is used as a pilot valve to communicate with the inlet passage and the outlet passage via the through hole before the incline surface of the valve member separates from a seat surface. However, the electromagnetic valve device for the gaseous fuel is not limited to the above configuration.

(c) According to the above embodiments, the seat member, which forms the valve seat, and the support member are integrally bonded to each other as one member. However, the seat member and the support member may be different members.

(d) According to the first and third embodiments, the magnetism blocking portion has the wall thickness from 0.6 mm to 0.9 mm. However, the wall thickness of the magnetism blocking portion is not limited. The wall thickness of the magnetism blocking portion may be any values as long as the wall thickness is less than that of the first small-diameter portion and the second small-diameter portion.

(e) According to the above embodiments, the magnetism blocking portion is provided at the position relatively far away from the position where the guide portion and the support member are connected with each other. However, a position of the magnetism blocking portion is not limited. The magnetism blocking portion is provided in the vicinity of the position where the guide portion and the support member are connected with each other.

(f) According to the above embodiments, the movable core and the guide portion are made of a magnetic stainless steel. However, material to form the movable core and the guide portion is not limited. The movable core and the guide portion may be made of any magnetic material.

(g) According to the above embodiments, the guide portion has chromium from 13 wt % to 17 wt %. However, a chromium content of the guide portion is not limited.

(h) According to the above embodiments, the plating film having a high abrasion resistance is provided on the side wall of the movable core. The side wall is arranged outside of the movable core 30 in the radial direction of the movable core, and is slidable in the guide portion. However, the plating film may be canceled.

(i) According to the fourth embodiment, the magnetism blocking portion is constructed by the non-magnetic portion and the magnetic portion. The non-magnetic portion is made of a non-magnetic material modified by the reformulation operation, and the magnetic portion is made of a magnetic material. Further, the non-magnetic portion is provided inside of the magnetic portion in the radial direction. However, a position relationship between the non-magnetic portion and the magnetic portion is not limited. The non-magnetic portion may be provided outside of the magnetic portion in the radial direction.

The present disclosure is not limited to the embodiments mentioned above, and can be applied to various embodiments within the spirit and scope of the present disclosure.

What is claimed is:

1. An electromagnetic valve device for a high-pressure fluid, the electromagnetic valve device comprising:
a coil assembly generating a magnetic force when being energized;
a stator core which is made of a magnetic material, and is excited when the coil assembly generates the magnetic force;
a movable core which is made of a magnetic material, and is moved to the stator core when the coil assembly generates the magnetic force;
a guide portion slidably receiving the movable core and being filled with the high-pressure fluid, the guide portion including
a magnetism blocking portion which blocks a magnetic flux over a whole periphery of a predetermined position in an axial direction of the guide portion, and
a magnetism passing portion through which the magnetic flux passes;
a valve member connected with the stator core; and
a seat member forming a valve seat abutting on or separating from the valve member to block or allow the flow of the high-pressure fluid, wherein
a magnetic circuit bypassing the magnetism blocking portion is generated between the magnetism passing portion of the guide portion and the movable core, when the coil assembly generates the magnetic force.

2. The electromagnetic valve device for a high-pressure fluid, according to claim 1, wherein
the magnetism blocking portion has a wall thickness that is less than a wall thickness of the magnetism passing portion.

3. The electromagnetic valve device for a high-pressure fluid, according to claim 2, wherein
the magnetism blocking portion has the wall thickness from 0.6 mm to 0.9 mm.

4. The electromagnetic valve device for a high-pressure fluid, according to claim 1, wherein
the magnetism blocking portion is a part of the guide portion where the predetermined position is modified to non-magnetic material by a reformulation operation in the axial direction of the guide portion.

5. The electromagnetic valve device for a high-pressure fluid, according to claim 1, further comprising
a support member supporting the guide portion, wherein
parts are provided in order of the support member, the seat member, the valve member, the movable core and the stator core, and
the magnetism blocking portion is provided between the stator core and the support member.

6. The electromagnetic valve device for a high-pressure fluid, according to claim 5, wherein
the magnetism blocking portion is provided at a position closer to the stator core than the support member.

7. The electromagnetic valve device for a high-pressure fluid, according to claim 1, wherein
the guide portion is made of a magnetic stainless steel.

8. The electromagnetic valve device for a high-pressure fluid, according to claim 1, wherein
the guide portion includes a chromium content from 13 wt % to 17 wt %.

9. The electromagnetic valve device for a high-pressure fluid, according to claim 1, further comprising
a biasing member provided between the stator core and the movable core, and biasing the movable core in a separating direction separating the movable core from the stator core.

10. The electromagnetic valve device for a high-pressure fluid, according to claim 1, wherein
the movable core is made of a magnetic stainless steel.

11. The electromagnetic valve device for a high-pressure fluid, according to claim 1, further comprising
a plating film having a abrasion resistance and provided on at least a part of the movable core radially outside of the movable core, wherein the part is slidable in the guide portion.

12. The electromagnetic valve device for a high-pressure fluid, according to claim 1, wherein
the plating film is made of a non-magnetic material.
